(19) United States
(12) Patent Application Publication
(10) Pub. No.: US 2025/0141236 A1
(43) Pub. Date: May 1, 2025

(54) METHOD OF INSTANT STARTUP AND GRID SYNCHRONIZATION OF INVERTER BASED RESOURCES

(71) Applicant: Florida State University Research Foundation, Inc., Tallahassee, FL (US)

(72) Inventors: Yuan Li, Tallahassee, FL (US); Yuchen He, Tallahassee, FL (US); Fang Peng, Tallahassee, FL (US)

(21) Appl. No.: 18/930,473

(22) Filed: Oct. 29, 2024

Related U.S. Application Data
(60) Provisional application No. 63/594,180, filed on Oct. 30, 2023.

(51) Int. Cl. H02J 3/44

(52) U.S. Cl. CPC H02J 3/44; H02J 2300/24; H02J 2300/28; H02J 2300/30

(57) ABSTRACT

Systems and methods for starting inverter-based resources (IBRs) and synchronizing them with their tied grid are provided. The startup can utilize direct current (DC) control throughout each switching cycle, enabling a process without any inrush current. This can mitigate the inrush current instantly or essentially instantly, thereby giving a transient-free inverter startup and grid synchronization.

### CROSS-REFERENCE TO RELATED APPLICATION

This application claims the benefit of U.S. Provisional Application Ser. No. 63/594,180, filed Oct. 30, 2023, the disclosure of which is hereby incorporated by reference in its entirety, including all figures, tables, and drawings.

### GOVERNMENT SUPPORT

This invention was made with government support under DE-EE0009340 awarded by the United States Department of Energy. The government has certain rights in the invention.

### BACKGROUND

Inverter-based resources (IBRs), such as solar and wind energy, are progressively being integrated into existing power grids towards grid de-carbonization. However, alongside the intermittency of renewable sources, the inertia-free characteristics of inverters often pose potential threats to the stability of the power system ([20]-[21]). As a countermeasure, most IBRs are managed to mimic the behavior of synchronous generators, adopting strategies like droop control, virtual inertia control, and virtual synchronous machines ([22]). Therefore, the startup procedures of many IBR-based systems continue to abide by conventional power system operation methodologies ([23], [24]).

### BRIEF SUMMARY

Embodiments of the subject invention provide novel and advantageous systems and methods for starting inverter-based resources (IBRs) and synchronizing them with their tied grid. The startup can utilize direct current (DC) control throughout each switching cycle, enabling a process without any inrush current (or with a very small amount of inrush current, such as less than 0.1 milliamp (mA)). This can mitigate the inrush current instantly or essentially instantly (i.e., the duration of the process can be less than 100 milliseconds (ms), or even less than 10 ms), thereby giving a transient-free inverter startup and grid synchronization.

In an embodiment, a method for starting one or more IBRs and synchronizing them with a grid can comprise: regulating a current of an inverter (e.g., an inverter of the grid or of the IBR(s)) to zero via a switching-cycle-based DC feedback loop with an input current of zero; generating an estimate of a grid phase angle of the grid using samples of the current of the inverter, a DC voltage of the inverter, and an inverter switching function; determining an initial voltage phase angle of the inverter based on the estimated grid phase angle of the grid; and switching to a regular control strategy using the initial voltage phase angle of the inverter. The IBRs can be synchronized with the grid in less than 100 ms (e.g., in less than 10 ms or instantly). An inrush current of the grid during the synchronizing of the IBRs with the grid can be less than 100 mA (e.g., less than 10 mA, less than 1 mA, or less than 0.1 mA). The inverter switching function can be generated using Equation 1 (as presented herein). The initial voltage phase angle of the inverter can be determined using Equations 2-3 (as presented herein). The regulating of the current of the inverter can comprise sampling the current of the inverter at each switching cycle and comparing the sampled inverter current with a reference value. At each switching cycle, either a first device of the inverter or a second device of the inverter can be switched, depending on whether the sampled inverter current is higher or lower than the reference value. The IBRs can comprise a solar panel, a wind turbine, a fuel cell, and/or a battery. The grid can be connected with a power plant, a microgrid, and/or a distributed generation grid.

In another embodiment, a system for starting one or more IBRs and synchronizing them with a grid can comprise: a processor; and a machine-readable medium in operable communication with the processor and an inverter (e.g., an inverter of the grid or of the IBR(s)) and having instructions stored thereon that, when executed by the processor, perform a method for energizing a transformer as disclosed herein (with any individual feature or combination of features or all features of the method as disclosed herein). The system can further comprise the inverter, the grid, the IBR(s), and/or any other element(s) within the grid or to which (or with which) the grid is connected. The system can further comprise a display in operable communication with the processor, the machine-readable medium, and/or the inverter of the transformer. Any results of the steps of the method of starting the IBR(s) and synchronizing them with the grid can be displayed on the display.

### BRIEF DESCRIPTION OF DRAWINGS

FIG. 1 shows a flow chart for starting inverter-based resources (IBRs) and synchronizing them with their tied grid, according to an embodiment of the subject invention.

FIG. 2 shows a circuit schematic of inverter DC control to estimate grid voltage, according to an embodiment of the subject invention.

FIG. 3 shows a circuit schematic of an analytical model for an inverter interfacing the grid.

FIG. 4 shows a system schematic for inverter direct current (DC) control to estimate grid voltage, according to an embodiment of the subject invention.

FIG. 5(a) shows plots of, from top to bottom, current (in per unit (p.u.)) versus time (in seconds(s)), voltage (p.u.) versus time (in s), reproduced sin θ_{g,a} versus time (in s), and reproduced cos θ_{g,a} versus time (in s).

FIG. 5(b) shows zoomed-in plots of, from top to bottom, current (p.u.) versus time (in s), reproduced sin θ_{g,a} versus time (in s), gate signal (Sₐₚ) versus time (in s), and gate signal (S_{bp}) versus time (in s). In the top plot, the (green) curve with the highest current value at a time of 0.0104 s is for i_{c}, the (blue) curve with the second-highest current value at a time of 0.0104 s is for i_{b}, and the (red) curve with the lowest current value at a time of 0.0104 s is for iₐ.

FIG. 6 shows eight waveforms with experimental results of IBR startup utilizing an approach according to an embodiment of the subject invention. In FIG. 6, the blue and red curves signify the phase A current (i_{La}) and the phase B current (i_{Lb}), respectively. The green and yellow lines are for the gating signal for the upper switch of phase A (Sₐₚ) and the gating signal for the upper switch of phase B (S_{bp}), respectively.

FIG. 7 shows a control diagram for an equivalent circuit of a three-phase grid-connected inverter startup.

### DETAILED DESCRIPTION

Embodiments of the subject invention provide novel and advantageous systems and methods for starting inverter-based resources (IBRs) and synchronizing them with their tied grid. The startup can utilize direct current (DC) control throughout each switching cycle, enabling a process without any inrush current (or with a very small amount of inrush current, such as less than 0.1 milliamp (mA)). This can mitigate the inrush current instantly or essentially instantly (i.e., the duration of the process can be less than 100 milliseconds (ms), or even less than 10 ms), thereby giving a transient-free inverter startup and grid synchronization.

Conventional IBR startup relies on sensing the three-phase grid voltage, which is subsequently fed into a phase-locked loop (PLL) to determine the phase angle. The circuit breaker is closed after the inverter voltage is established and locked to be in phase with the grid voltage. The limitation is the bandwidth of PLL must remain below a certain range (i.e., less than 200 Hertz (Hz)) to guarantee system stability and decouple its dynamics from the inner current control loop ([1]-[4]). This limitation restricts the synchronization process, prolonging its duration. Further, in cases of large grid impedance in a weak grid, measured voltage cannot reflect the true grid voltage, and this discrepancy can result in a phase difference and inrush currents, ultimately causing synchronization failures.

Other methods that attempt to address the drawbacks introduced by PLL include voltage sensor-less control methods. Inverter current (i_{L}) is measured to estimate v_{pcc} analytically through a physical model, or from virtual flux- and observer-based methods ([6]-[15]). However, these methods don't address the startup and synchronization issue because i_{L} needs to be established first for these algorithms (in a few line cycles), whereas the inrush current could occur already (in a few inverter switching cycles). A bumpless start can be used by setting current reference to zero, but the controller's transient duration remains long (˜a few line cycles) ([16]). A short-time zero voltage vector can be injected, and the line current derivative can be used to estimate the initial grid phase angle ([17]-[19]), but the risk of over-current still exists if using a small filter inductor or in a stiff grid.

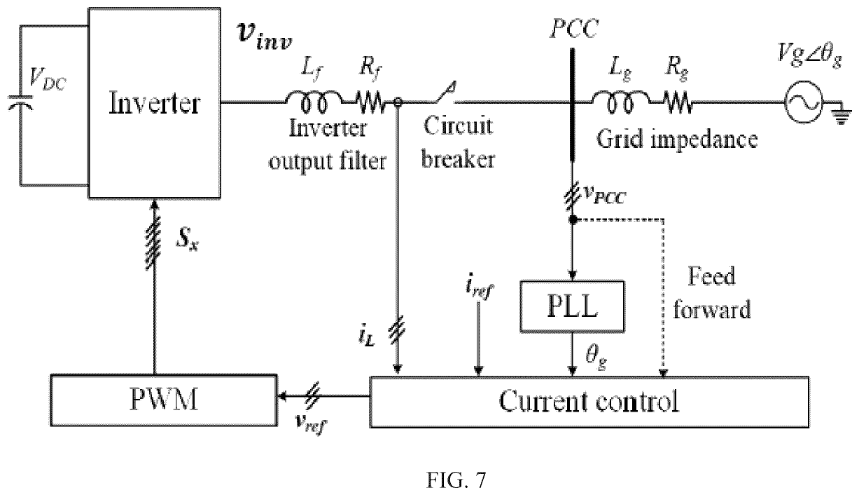

FIG. 7 shows a typical control diagram for a three-phase grid-connected inverter startup, exemplified with an inductor filter as the output filter, denoted by L_{f} and its equivalent series resistance (ESR), R_{f}. Conventional IBR startup relies on sensing the three-phase grid voltage v_{pcc} (V_{pcc}=V_{pcc,a}, V_{pcc,b}, V_{pcc,c}]^{T} where subscript a, b, and c represent phase a, b and c, respectively), which is subsequently fed into a PLL to determine the phase angle θ_{g}. The circuit breaker is closed after vᵢₙᵥ is established and locked to be in phase with v_{pcc}. The barrier is that the bandwidth of PLL must remain below a certain range (<200 Hz) to guarantee system stability and decouple its dynamics from the inner current control loop ([1]-[4]). This limitation restricts the synchronization process, prolonging its duration. Also, for the same reason a typical inverter level control in a hierarchical control scheme for the IBR based system remains about 1 second(s) to 10 s ([5]). Further, in cases of large grid impedance in a weak grid (represented by L_{g} and R_{g} in FIG. 7), v_{pcc} cannot reflect the true grid voltage v_{g}. This discrepancy can result in a phase difference and inrush currents, ultimately causing synchronization failures.

Embodiments of the subject invention provide systems and methods to start IBRs and synchronize with its tied grid by switching cycle-based DC control. Traditional grid synchronization relies on inverter output voltage measurement, a PLL, and voltage feedback control. In contrast, embodiments of the subject invention are based on inverter current measurement and current feedback control of each switching cycle, where PLL is not used. Embodiments mitigate the inrush current instantly (or essentially instantly) for a transient free inverter startup and grid synchronization.

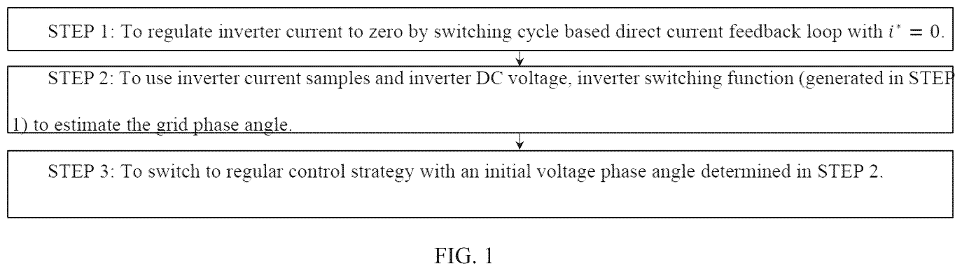

FIG. 1 shows a flow chart for starting IBRs and synchronizing them with their tied grid, according to an embodiment of the subject invention. Referring to FIG. 1, in a first step, inverter current can be regulated to zero by switching-cycle-based DC feedback loop with i*=0. In a second step, inverter current samples, inverter DC voltage, and an inverter switching function (which can be generated in the first step) can be used to estimate the grid phase angle. In a third step, regular control strategy can be switched with an initial voltage phase angle determined in the second step.

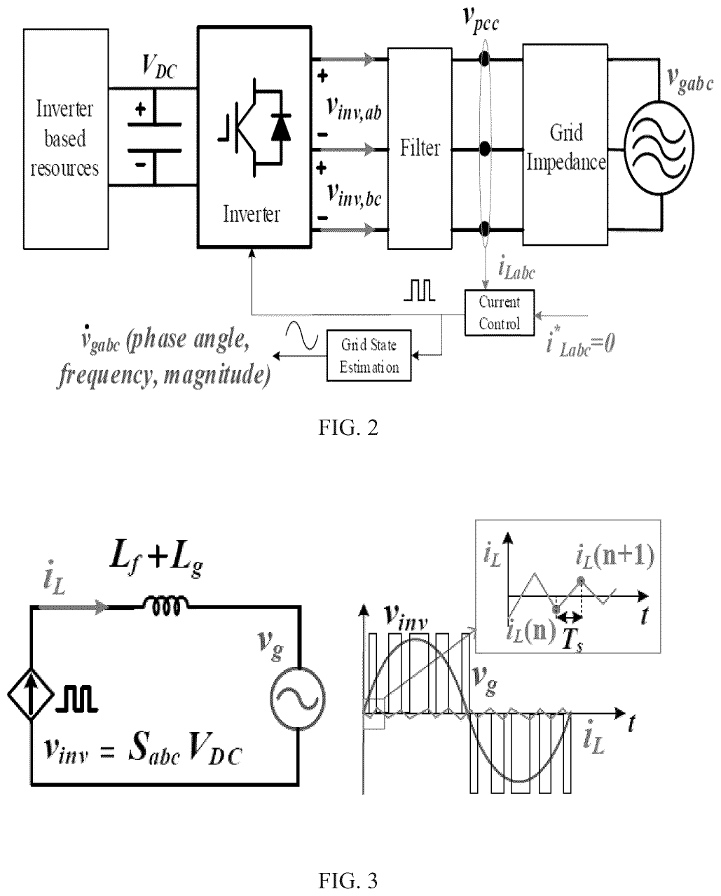

With respect to the first step (DC feedback control, FIG. 2 shows a three-phase inverter interfacing the grid, the input of which can be any IBR (e.g., photovoltaic (PV) panels, batteries, fuel cells, wind turbine generators, etc.). The pulse-width modulation (PWM) signals can be generated by DC control loop with an inverter current reference i_{L}*=0. The inverter current i_{L} can be sampled periodically at each switching cycle (Ts) and compared with the reference. Depending on the error sign, either the upper or the lower devices can be switched. The inrush current can be regulated to zero (or very close to zero) from the very beginning when the inverter is starting to switch. It is notable that there is current difference over each sampling period (Δi/Δt), and it can be used to estimate the grid state in the next step.

With respect to the second step (grid phase angle estimation), in order to illustrate the principle, an analytical model for a three-phase voltage source inverter interfacing grid can be established as in FIG. 3. Based on this model, differential equations can be derived, including Equation 1, where S_{abc} is the switching function generated in first step by DC control, V_{DC} is the DC voltage, L_{f} is the filter, L_{g} represents the grid inductance, and v_{g} is the grid voltage.

$${S}_{abc} \cdot {V}_{D C} - {v}_{g} = ( {L}_{f} + {L}_{g} ) \frac{{di}_{L}}{dt} \qquad ( 1 )$$

The phase angle (θₐ) can be further derived from Equation 1 as shown in Equation 2.

$$\{ \begin{matrix}sin {θ}_{a} ( n + 1 ) = \frac{2 {V}_{D C} ( 1 + {K}_{a} )}{3 {V}_{g} ( {K}_{a} - 1 )} \\ cos {θ}_{a} ( n + 1 ) = - \frac{2 \sqrt{3} {V}_{D C}}{9 {V}_{g}} ( \frac{1 + {K}_{a}}{{K}_{a} - 1} + \frac{1 + {K}_{b}}{1 - {K}_{b}} )\end{matrix} \qquad ( 2 )$$

$$where$$

$$\{ \begin{matrix}{K}_{a} = \frac{{i}_{La} ( n + 1 ) - {i}_{La} ( n )}{{i}_{La} ( n + 1 ) - {i}_{La} ( n + 1 )} \\ {K}_{b} = \frac{{i}_{Lb} ( n + 1 ) - {i}_{Lb} ( n )}{{i}_{Lb} ( n + 1 ) - {i}_{Lb} ( n + 1 )}\end{matrix} \qquad ( 3 )$$

In Equation 3, Kₐ and K_{b} are coefficients derived from the current difference from both phase A and B over switching cycle Tₛ, and V_{g} is the grid voltage magnitude.

Further with respect to deriving Equation 2, if it is assumed that an arbitrary initial gating signal for the upper switches of each phase is 011, discretizing and rearranging Equation 1 yields the current difference of phase A current over the duration of the given gating signal, as well as the current slope for phase B current (Equations 4 and 5, respectively).

$${A}_{1 , a} = \frac{{i}_{La} ( n + 1 ) - {i}_{La} ( n )}{{T}_{s}} = \frac{1}{3 L} ( - 2 {V}_{D C} - 3 {v}_{g , a} ( n + 1 ) ) \qquad ( 4 )$$

$${A}_{1 , b} = \frac{{i}_{Lb} ( n + 1 ) - {i}_{Lb} ( n )}{{T}_{s}} = \frac{1}{3 L} ( {V}_{D C} + 3 {v}_{g , b} ( n + 1 ) ) \qquad ( 5 )$$

The switching state then changes to the complimentary state of the previous state (i.e., 011) for the sake of reducing the inrush current, and the phase A current slope becomes as shown in Equation 6.

$${A}_{2 , a} = \frac{{i}_{La} ( n + 1 ) - {i}_{La} ( n + 1 )}{{T}_{s}} = \frac{1}{3 L} ( 2 {V}_{D C} - 3 {v}_{g , a} ( n + 2 ) ) \qquad ( 6 )$$

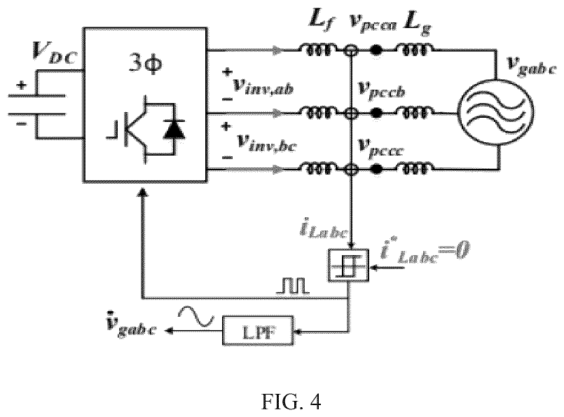

Because the switching cycle is significantly shorter than the fundamental cycle of the grid, the grid phase angle change can be neglected during the switching cycle period (i.e., θₐ (n)=θₐ (n+1)=θₐ (n+2). Theoretically only two switching cycles are needed to obtain the grid phase angle, with two arbitrary signals (S_{abc}(0) and S_{abc} (1)) provided. It can be noted that, because S_{abc}(0) and S_{abc}(1) can be arbitrary, DC control can be applied for line current mitigation. Specifically, if the hysteresis control method shown (for exemplary purposes only) in FIG. 4, the resulting PWM signal can also be effectively employed as a switching command, thereby enabling the acquisition of the desired phase angle (see also [27], which is hereby incorporated by reference herein in its entirety).

Also, in FIG. 3, it can be assumed that the three-phase voltage source inverter is connected to the grid under the following conditions: 1) all three phases are balanced; 2) no deviation in the grid voltage magnitude occurs; and 3) the current sampling rate vastly exceeds the line frequency, thereby ensuring that the estimated phase angle remains static within two switching cycles. This assumption holds true for most practical grids, as the duration of two switching cycles is less than 1 ms, which is at least an order of magnitude shorter than the grid period.

Embodiments of the subject invention can control line current i_{L} to zero (i_{L}*=0) by switching-cycle-based DC control. Because there is still a line current difference (Δi_{L}/Δt) for each switching cycle, the grid voltage phase angle can be estimated based on Δi_{L}/Δt and then the inverter output can be controlled to synchronize with the grid. Significant advantages include: 1) the inrush current can be mitigated starting from the very first switching cycle, which means the magnitude of the inrush current can be mitigated to the maximum extent; and 2) no voltage measurement and/or PLL is needed, and the control loop bandwidth is increased to the switching frequency, so startup transient duration is minimized.

Traditional synchronous generators are continuous voltage sources where phase angle or frequency cannot be changed immediately. Current transient during the synchronization process must rely on the voltage measurement and PLL. However, IBRs can be regarded as a digital voltage source whose phase angle can be discontinuous (e.g., within the 50-60 Hz frequency range). The DC feedback loop enables both zero inrush current (or nearly zero inrush current) and the grid phase estimation. Thus, instant (or essentially instant) grid synchronization can be achieved. Because there are already sensors for DC voltage and line current (inverter output current) measurement, no extra hardware is needed.

Embodiments of the subject invention can be implemented by commercial grid-connected inverters, such as PV inverters, battery inverters, and others, that interface renewable energy sources to a utility grid. Embodiments can realize ultra-fast black start of a power plant, such as a PV power plant (or a PV plus battery hybrid power plant, or distributed generation in a microgrid) to synchronize with the grid, and ultimately to support the bulk power system recovery from blackouts.

Embodiments of the subject invention can control line current to zero by switching-cycle-based DC control. Because there is still a line current difference for each switching cycle, the grid voltage phase angle can be estimated based on the line current difference and then the inverter output can be controlled to synchronize with the grid. Significant advantages of this approach include: 1) the inrush current will be mitigated starting from the very first switching cycle, which means the magnitude of inrush current will be mitigated to the maximum extent; and 2) no voltage measurement and PLL is needed, and the control loop bandwidth is increased to the switching frequency, so startup transient duration is minimized.

Embodiments of the subject invention mitigate inrush current magnitude during IBR startup process and grid synchronization, while also minimizing the duration of the startup transient. The traditional control for IBRs is to mimic a synchronous generator with voltage feedback loop, through which all IBRs are controlled as a continuous voltage sources that phase angle or frequency cannot be changed immediately. However, in embodiments of the subject invention, IBRs can be regarded as a digital voltage source whose phase angle can be discontinuous. The DC feedback loop can enable both zero inrush current (or nearly zero inrush current, such as less than 100 mA, less than 10 mA, less than 1 mA, or less than 0.1 mA) and grid phase estimation. Thus, instant (or essentially instant, such as less than 100 ms or less than 10 ms) grid synchronization can be achieved.

Embodiments of the subject invention can be used to startup grid-connected inverters, including but not limited to PV inverters, battery inverters, fuel cell inverters, and/or wind turbine generation/inverters. Embodiments can be applied to, for example, power plants, microgrids, and/or distributed generation to instantly (or essentially instantly) startup inverters and connect them to the grid.

Embodiments of the subject invention provide instant (or essentially instant) startup of IBRs, which attains synchronization with the grid via the already embedded DC feedback control. The startup process can utilize DC control throughout each switching cycle, enabling a process that is free from inrush current (or essentially free from inrush current). Uniquely, embodiments determine the grid phase angle by evaluating the current differences across switching cycles, a significant difference from traditional methods that often rely on grid voltage or points of common coupling (PCC) voltage.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1

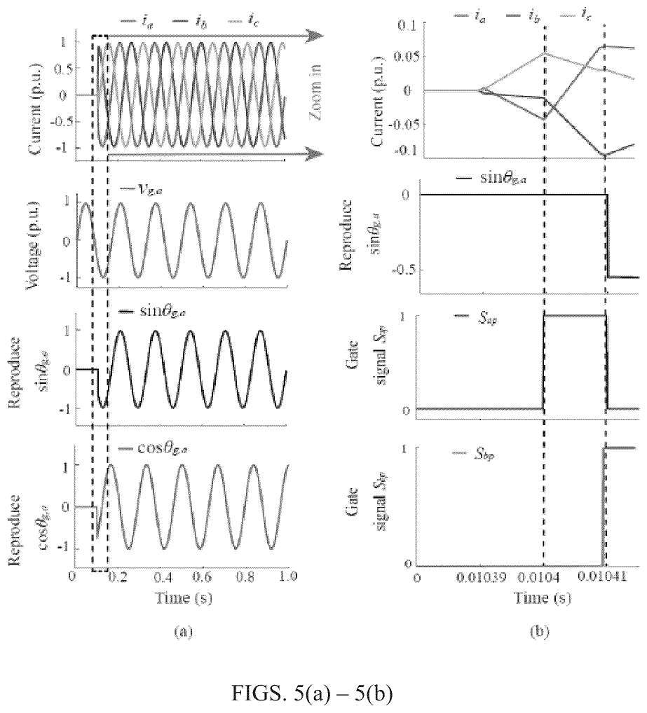

A simulation was run to test the startup approach for IBRs synchronizing with the grid, according to embodiments of the subject invention, as shown in, for example, FIGS. 1, 2, and 3. FIGS. 5(a) and 5(b) show the simulation results. The inverter is joined to the grid at t=0.01 s and no current flows between the inverter and the grid prior to this. The startup mechanism initiates operation within two switching cycles as soon as the inverter establishes the connection. During this time, the grid phase voltage (represented by sin θₐ and cos θₐ) is obtained. The results show that the reproduced sin θₐ is perfectly synchronized with the grid voltage, thus achieving synchronization in a timeframe of two switching cycles, which is at least an order of magnitude faster than traditional startup approaches, thereby underlining the advantages and utility of instant (or essentially instant) startup for the IBRs.

### Example 2

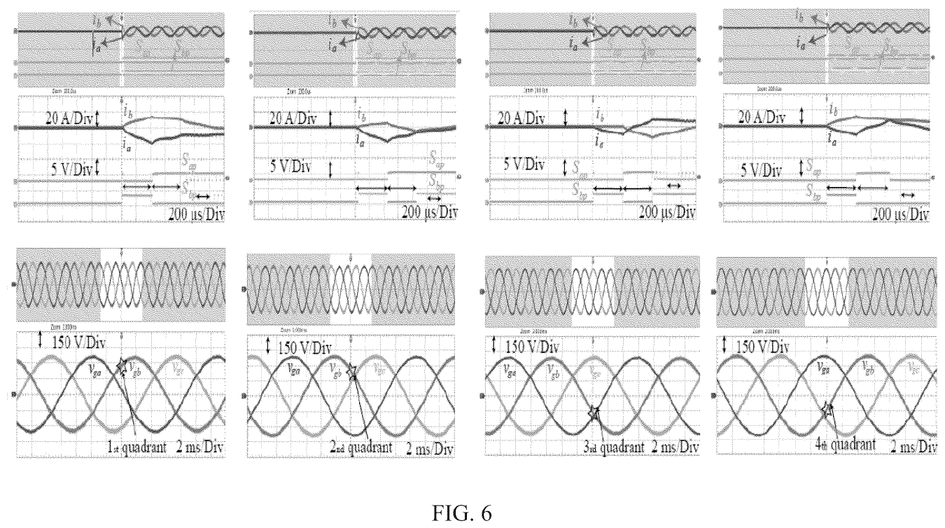

An experiment was conducted to test the startup approach for IBRs synchronizing with the grid, according to embodiments of the subject invention, as shown in, for example, FIGS. 1, 2, and 3. FIG. 6 shows the simulation results. The curves signify the phase A current, i_{La}, and the phase B current, i_{Lb}, along with the gating signals for the upper switch of phases A and B. The inverter is steered from the startup phase until the zero current control, eventually escalating to the rated current. The inverter's startup process is remarkably swift with negligible transient currents. From the presented results, it becomes evident that the startup process can successfully function across all four quadrants of grid voltages. Thus, it can be concluded that this startup approach offers reliable synchronization with the grid, achievable within just two switching cycles.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including in the “References” section, if present) are incorporated by reference in their entirety, including all figures and tables, to the extent they are not inconsistent with the explicit teachings of this specification.

### REFERENCES

[1] L. Harnefors, “Modeling of Three-Phase Dynamic Systems Using Complex Transfer Functions and Transfer Matrices,” in IEEE Transactions on Industrial Electronics, vol. 54, no. 4, pp. 2239-2248 August 2007, doi: 10.1109/TIE.2007.894769.
[2] X. Wang and F. Blaabjerg, “Harmonic Stability in Power Electronic-Based Power Systems: Concept, Modeling, and Analysis,” in IEEE Transactions on Smart Grid, vol. 10, no. 3, pp. 2858-2870 May 2019, doi: 10.1109/TSG.2018.2812712.
[3] B. Wen, D. Boroyevich, R. Burgos, P. Mattavelli and Z. Shen, “Analysis of D-Q Small-Signal Impedance of Grid-Tied Inverters,” in IEEE Transactions on Power Electronics, vol. 31, no. 1, pp. 675-687, January 2016, doi: 10.1109/TPEL.2015.2398192.
[4] D. Dong, B. Wen, D. Boroyevich, P. Mattavelli and Y. Xue, “Analysis of Phase-Locked Loop Low-Frequency Stability in Three-Phase Grid-Connected Power Converters Considering Impedance Interactions,” in IEEE Transactions on Industrial Electronics, vol. 62, no. 1, pp. 310-321, January 2015, doi: 10.1109/TIE.2014.2334665.
[5] T. Kerdphol, F. S, Rahman, M. Watanabe, Y. Mitani, D. Turschner and H.-P. Beck, “Enhanced Virtual Inertia Control Based on Derivative Technique to Emulate Simultaneous Inertia and Damping Properties for Microgrid Frequency Regulation,” in IEEE Access, vol, 7, pp. 14422-14433, 2019, doi: 10.1109/ACCESS.2019.2892747
[6] M. Malinowski and S. Bernet, “A Simple Voltage Sensorless Active Damping Scheme for Three-Phase PWM Converters With an LCL Filter,” in IEEE Transactions on Industrial Electronics, vol. 55, no. 4, pp. 1876-1880 April 2008, doi: 10.1109/TIE.2008.917066.
[7] V. Roy Chowdhury, S. Mukherjee and J. Kimball, “A Voltage Sensorless Control of a Three Phase Grid Connected Inverter Based on Lyapunov Energy Function Under Unbalanced Grid Voltage Condition,” 2018 IEEE Energy Conversion Congress and Exposition (ECCE), Portland, OR, USA, 2018, pp. 4884-4888, doi: 10.1109/ECCE.2018.8558434.
[8] H. Gholami-Khesht, M. Monfared, and S. Golestan “Low computational burden grid voltage estimation for grid connected voltage source converterbased power applications,” IET Power Electron., vol. 8, no. 5, pp. 656-664, May 2015.
[9] J. A. Suul, A. Luna, P. Rodriguez and T. Undeland, “Voltage-Sensor-Less Synchronization to Unbalanced Grids by Frequency-Adaptive Virtual Flux Estimation,” in IEEE Transactions on Industrial Electronics, vol. 59, no. 7, pp. 2910-2923 July 2012, doi: 10.1109/TIE.2011.2168793.
[10] M. B. Ketzer and C. B. Jacobina, “Virtual Flux Sensorless Control for Shunt Active Power Filters With Quasi-Resonant Compensators,” in IEEE Transactions on Power Electronics, vol. 31, no. 7, pp. 4818-4830 July 2016, doi: 10.1109/TPEL.2015.2487298.
[11] A. Rahoui, A. Bechouche, H. Seddiki, and D. O. Abdeslam, “Virtual flux estimation for sensorless predictive control of PWM rectifiers under unbalanced and distorted grid conditions,” IEEE J. Emerg. Sel. Topics Power Electron., to be published, doi: 10.1109/JESTPE.2020.2970042.
[12] J. Kukkola and M. Hinkkanen, “State Observer for Grid-Voltage Sensorless Control of a Converter Under Unbalanced Conditions,” in IEEE Transactions on Industry Applications, vol. 54, no. 1, pp. 286-297, January-February 2018, doi: 10.1109/TIA.2017.2749305.
[13] T. V. Tran and K.-H. Kim, “Frequency Adaptive Grid Voltage Sensorless Control of LCL-Filtered Inverter Based on Extended Model Observer,” in IEEE Transactions on Industrial Electronics, vol. 67, no. 9, pp. 7560-7573 September 2020, doi: 10.1109/TIE.2019.2944075.
[14] R. A. Fantino, C. A. Busada and J. A. Solsona, “Observer-Based Grid-Voltage Sensorless Synchronization and Control of a VSI-LCL Tied to an Unbalanced Grid,” in IEEE Transactions on Industrial Electronics, vol. 66, no. 7, pp. 4972-4981 July 2019, doi: 10.1109/TIE.2018.2868255.
[15] B. Wang, Y. Xu, Z. Shen, J. Zou, C. Li and H. Liu, “Current Control of Grid-Connected Inverter With LCL Filter Based on Extended-State Observer Estimations Using Single Sensor and Achieving Improved Robust Observation Dynamics,” in IEEE Transactions on Industrial Electronics, vol. 64, no. 7, pp. 5428-5439 July 2017, doi: 10.1109/TIE.2017.2674600.
[16] D. Pérez-Estévez and J. Doval-Gandoy, “Grid-Tied Inverter With AC Voltage Sensorless Synchronization and Soft Start,” in IEEE Transactions on Industry Applications, vol. 55, no. 5, pp. 4920-4933 September-October 2019, doi: 10.1109/TIA.2019.2921707.
[17] H. Yoo, J.-H. Kim and S.-K. Sul, “Sensorless Operation of a PWM Rectifier for a Distributed Generation,” in IEEE Transactions on Power Electronics, vol. 22, no. 3, pp. 1014-1018 May 2007, doi: 10.1109/TPEL.2007.897094.
[18] K. Upamanyu, C. Ameta and G. Narayanan, “Simplified Input Voltage Sensorless Vector Control for PWM Rectifiers,” in IEEE Transactions on Industry Applications, vol. 56, no. 4, pp. 4051-4060 July-August 2020, doi: 10.1109/TIA.2020.2992955.
[19] S. He, D. Zhou, X. Wang and F. Blaabjerg, “Line Voltage Sensorless Control of Grid-Connected Inverters Using Multisampling,” in IEEE Transactions on Power Electronics, vol. 37, no. 4, pp. 4792-483 April 2022, doi: 10.1109/TPEL.2021.3123786.
[20] H. Jain, G.-S. Seo, E. Lockhart, V. Gevorgian and B. Kroposki, “Blackstart of Power Grids with Inverter-Based Resources,” 2020 IEEE Power & Energy Society General Meeting (PESGM), Montreal, QC, Canada, 2020, pp. 1-5, doi: 10.1109/PESGM41954.2020.9281851.
[21] B. Fan, T. Liu, F. Zhao, H. Wu and X. Wang, “A Review of Current-Limiting Control of Grid-Forming Inverters Under Symmetrical Disturbances,” in IEEE Open Journal of Power Electronics, vol. 3, pp. 955-969, 2022, doi: 10.1109/OJPEL.2022.3227507.
[22] Q. C. Zhong and G. Weiss, “Synchronverters: Inverters That Mimic Synchronous Generators,” in IEEE Transactions on Industrial Electronics, vol. 58, no. 4, pp. 1259-1267 April 2011, doi: 10.1109/TIE.2010.2048839.
[23] H. Li, C. Nie and F. Wang, “Grid Strengthening IBR: An Inverter-Based Resource Enhanced by a Co-Located Synchronous Condenser for High Overcurrent Capability,” in IEEE Open Journal of Power Electronics, vol. 3, pp. 535-548, 2022, doi: 10.1109/OJPEL.2022.3194849.
[24] Y. Men, Y. Du and X. Lu, “Distribution System Restoration Using Dynamic Microgrids with Inverter-Interfaced Black-Start Generation Units,” 2022 IEEE 13th International Symposium on Power Electronics for Distributed Generation Systems (PEDG), Kiel, Germany, 2022, pp. 1-5, doi: 10.1109/PEDG54999.2022.9923297.
[25] X. Wang, F. Blaabjerg and W. Wu, “Modeling and Analysis of Harmonic Stability in an AC Power-Electronics-Based Power System,” in IEEE Transactions on Power Electronics, vol. 29, no. 12, pp. 6421-6432 December 2014, doi: 10.1109/TPEL.2014.2306432.
[26] T. L. Vandoorn, J. C. Vasquez, J. De Kooning, J. M. Guerrero and L. Vandevelde, “Microgrids: Hierarchical Control and an Overview of the Control and Reserve Management Strategies,” in IEEE Industrial Electronics Magazine, vol. 7, no. 4, pp. 42-55, December 2013, doi: 10.1109/MIE.2013.2279306.
[27] Y. He, Y. Li, B. Zhou, Y. Zou and F. Z. Peng, “An Ultra-Fast Inrush-Current-Free Startup Method for Grid-tie Inverter without Voltage Sensors,” 2023 IEEE Applied Power Electronics Conference and Exposition (APEC), Orlando, FL, USA, 2023, pp. 2874-2880, doi: 10.1109/APEC43580.2023.10131356.

What is claimed is:

1. A method for starting inverter-based resources (IBRs) and synchronizing them with a grid, the method comprising:
regulating a current of an inverter to zero via a switching-cycle-based direct current (DC) feedback loop with an input current of zero;
generating an estimate of a grid phase angle of the grid using samples of the current of the inverter, a DC voltage of the inverter, and an inverter switching function;
determining an initial voltage phase angle of the inverter based on the estimated grid phase angle of the grid; and
switching to a regular control strategy using the initial voltage phase angle of the inverter.

2. The method according to claim 1, wherein the IBRs are synchronized with the grid in less than 100 milliseconds (ms).

3. The method according to claim 1, wherein an inrush current of the grid during the synchronizing of the IBRs with the grid is less than 10 milliamps (mA).

4. The method according to claim 3, wherein an inrush current of the grid during the synchronizing of the IBRs with the grid is less than 0.1 mA.

5. The method according to claim 1, wherein the inverter switching function is generated using Equation 1 as follows:
$${S}_{abc} \cdot {V}_{D C} - {v}_{g} = ( {L}_{f} + {L}_{g} ) \frac{{di}_{L}}{dt} \qquad ( 1 )$$
where S_{abc} is the inverter switching function, V_{DC} is the DC voltage of the inverter, L_{f} is a filter, L_{g} represents a grid inductance, and v_{g} is a voltage of the grid.

6. The method according to claim 1, wherein the initial voltage phase angle of the inverter is determined using Equation 2 as follows:
$$\{ \begin{matrix}sin {θ}_{a} ( n + 1 ) = \frac{2 {V}_{D C} ( 1 + {K}_{a} )}{3 {V}_{g} ( {K}_{a} - 1 )} \\ cos {θ}_{a} ( n + 1 ) = - \frac{2 \sqrt{3} {V}_{D C}}{9 {V}_{g}} ( \frac{1 + {K}_{a}}{{K}_{a} - 1} + \frac{1 + {K}_{b}}{1 - {K}_{b}} )\end{matrix} \qquad ( 2 )$$
where θₐ is the initial voltage phase angle of the inverter, V_{DC} is the DC voltage of the inverter, Kₐ and K_{b} are coefficients derived from the current difference from both phase A and phase B over a switching cycle, and V_{g} is a magnitude of a voltage of the grid.

7. The method according to claim 1, wherein the regulating of the current of the inverter comprises sampling the current of the inverter at each switching cycle and comparing the sampled inverter current with a reference value.

8. The method according to claim 7, wherein, at each switching cycle, either a first device of the inverter or a second device of the inverter is switched, depending on whether the sampled inverter current is higher or lower than the reference value.

9. The method according to claim 1, wherein the IBRs comprise a solar panel, a wind turbine, a fuel cell, and/or a battery.

10. The method according to claim 1, wherein the grid is connected with a power plant, a microgrid, and/or a distributed generation grid.

11. A system for starting inverter-based resources (IBRs) and synchronizing them with a grid, the system comprising:
a processor; and
a machine-readable medium in operable communication with the processor and an inverter and having instructions stored thereon that, when executed by the processor, perform the following steps:
regulating a current of an inverter to zero via a switching-cycle-based direct current (DC) feedback loop with an input current of zero;
generating an estimate of a grid phase angle of the grid using samples of the current of the inverter, a DC voltage of the inverter, and an inverter switching function;
determining an initial voltage phase angle of the inverter based on the estimated grid phase angle of the grid; and
switching to a regular control strategy using the initial voltage phase angle of the inverter.

12. The system according to claim 11, wherein the IBRs are synchronized with the grid in less than 100 milliseconds (ms).

13. The system according to claim 11, wherein an inrush current of the grid during the synchronizing of the IBRs with the grid is less than 10 milliamps (mA).

14. The system according to claim 13, wherein an inrush current of the grid during the synchronizing of the IBRs with the grid is less than 0.1 mA.

15. The system according to claim 11, wherein the inverter switching function is generated using Equation 1 as follows:
$${S}_{abc} \cdot {V}_{D C} - {v}_{g} = ( {L}_{f} + {L}_{g} ) \frac{{di}_{L}}{dt} \qquad ( 1 )$$
where S_{abc} is the inverter switching function, V_{DC} is the DC voltage of the inverter, L_{f} is a filter, L_{g} represents a grid inductance, and v_{g} is a voltage of the grid.

16. The system according to claim 11, wherein the initial voltage phase angle of the inverter is determined using Equation 2 as follows:
$$\{ \begin{matrix}sin {θ}_{a} ( n + 1 ) = \frac{2 {V}_{D C} ( 1 + {K}_{a} )}{3 {V}_{g} ( {K}_{a} - 1 )} \\ cos {θ}_{a} ( n + 1 ) = - \frac{2 \sqrt{3} {V}_{D C}}{9 {V}_{g}} ( \frac{1 + {K}_{a}}{{K}_{a} - 1} + \frac{1 + {K}_{b}}{1 - {K}_{b}} )\end{matrix} \qquad ( 2 )$$
where θₐ is the initial voltage phase angle of the inverter, V_{DC} is the DC voltage of the inverter, Kₐ and K_{b} are coefficients derived from the current difference from both phase A and phase B over a switching cycle, and V_{g} is a magnitude of a voltage of the grid.

17. The system according to claim 11, wherein the regulating of the current of the inverter comprises sampling the current of the inverter at each switching cycle and comparing the sampled inverter current with a reference value.

18. The system according to claim 17, wherein, at each switching cycle, either a first device of the inverter or a second device of the inverter is switched, depending on whether the sampled inverter current is higher or lower than the reference value.

19. The system according to claim 11, wherein the IBRs comprise a solar panel, a wind turbine, a fuel cell, and/or a battery.

20. The system according to claim 11, wherein the grid is connected with a power plant, a microgrid, and/or a distributed generation grid.
